(19) United States
(12) Patent Application Publication
(10) Pub. No.: US 2005/0203835 A1
(43) Pub. Date: Sep. 15, 2005

(54) Internet billing

(76) Inventors: Eli Nhaissi, Old Westbury, NY (US); Aviv Refuah, Tel-Aviv (IL); Zeev Refuah, Tel-Aviv (IL); Maier Fenster, Petach Tikva (IL)

Correspondence Address: WOLF, BLOCK, SCHORR & SOLIS-COHEN LLP, 250 PARK AVENUE, NEW YORK, NY, 10177, US

(21) Appl. No.: 09/744,102

(22) PCT Filed: Jul. 20, 1999
(86) PCT No.: PCT/IL99/00399

§ 371 Date: Mar. 16, 2001

Related U.S. Application Data
(63) Continuation-in-part of application No. 09/601,385, filed on Jul. 28, 2000.
(60) Provisional application No. 60/103,473, filed on Oct. 8, 1998.

(30) Foreign Application Priority Data
Jul. 20, 1998 (IL) 125432
Jan. 30, 1998 (IL) 123129

(51) Int. Cl. G06F 17/60

(52) U.S. Cl. 705/39; 705/40

(57) ABSTRACT

A method of pre-paid Internet access, comprising: accessing an Internet using a prepaid account, which access deducts from a balance of said account; and performing one or more activities while connected to said Internet, which activities modify said balance additionally to said accessing. These activities may increase or decrease the balance.

### FIELD OF THE INVENTION

The present invention is related to the filed of Internet access and in particular to methods and apparatus for charging for Internet access.

### BACKGROUND OF THE INVENTION

The Internet is generally accessed using one of two methods, either by a dial-up connection from a personal computer to an ISP (Internet Service Provider) or through a LAN to a computer which is connected to an Internet. Additionally, Internet Cafes are institutions where a person may walk in and access the Internet. Some such institutions, for example Sannela Global Systems, provide a prepaid card which allows a limited access to the facilities.

Auric, inc., provides an “Intercard” system, in which a user uses a card having a pre-assigned user/password combination. When the user calls up a toll free 800 number, he enters this user/password information into his web browser and receives a certain amount of Internet access time. Further details are discussed in Auric's web site at “http://www.auricweb.com”, downloaded on Jun. 3, 1998, the disclosure of which is incorporated herein by reference. It should be noted that an e-mail account is not provided with the card.

U.S. Pat. No. 5,749,075, the disclosure of which is incorporated herein by reference, describes a prepaid Internet access card, in which the card number and pin number are dialed, as in a prepaid long distance telephone card, to provide a connection to an Internet supplier. To use the Internet access, a user is required to call up a toll free number, enter the card and pin numbers and then either download or receive by mail an Internet access software suitable for utilizing the Internet access. During the toll-free call, the user is prompted for various personal information which may be stored in a database in association with the card/pin numbers.

The Auric method and the '075 patent provide relatively anonymous ways of accessing the Internet. It should be noted that, in general, Internet access is anonymous since there is no information regarding the user on the Internet. However, an Internet address of the user must be provided in order for Internet access to work. Additionally, text files may be generated at the user's computer by remote Internet sites, in order to track personalizations of Internet access. These text files are called “cookies” and, although they may be blocked, proper operation of many Internet sites requires that cookies be allowed to be written.

Thus, it may be possible for a remote Internet site to amass personalized information about a user, even against his wishes.

### SUMMARY OF THE INVENTION

One object of some preferred embodiments of the invention is to provide a method of accessing the Internet. Preferably, the method allows a user to have geographic freedom in accessing the Internet. Alternatively or additionally, the method allows the user to access the Internet anonymously.

Another object of some preferred embodiments of the invention is to provide methods and apparatus for billing for Internet access, preferably using prepaid amounts.

One aspect of some preferred embodiments of the invention relates to prepaid access to an Internet. In a preferred embodiment of the invention, a pre-paid Internet access card comprises a number and a password, which may be printed on a credit-card size card. In addition, the card has associated with it a sum of money and/or Internet access time. In a preferred embodiment of the invention, a user may modify the password associated with a card number. Alternatively or additionally, in a login process using the card, a user may identify himself as a particular user, not coinciding with the card number, but preferably associated therewith. The term “card” is used herein as a convenience, in many embodiments, a card will not be in existence, only an account.

In a preferred embodiment of the invention, the information associated with the card may be used to modify and/or limit the access of the card user to the Internet, for example, the user may be blocked from accessing pornographic sites or sites which promote gambling. Alternatively or additionally, the card user may be limited to accessing certain promotional sites. Alternatively or additionally, a card user may be blocked and/or obstructed from accessing sites in which payment for services using the pre-paid card is not possible. Alternatively or additionally, the card user may be forced to use certain services, for example a WWW address finder which adds advertisements. Alternatively or additionally, the information may be used to personalize Internet access and/or advertisements. Such limitations on the card usage may be created before card is purchased, for example by a distributor or even after the card is purchased, for example by a parent. Such limitations may be applied, for example by calling in to a service center or via the Internet, when logged on using the card. Some of these limitations may be fixed. Others may be reversible using a password, for example a password supplied when applying the limitations.

In a preferred embodiment of the invention, a credit balance of a prepaid card may be used to send money to a bank account and/or for Internet telephony and/or for other types of electronic commerce.

Another aspect of some preferred embodiments of the invention relates to reducing and/or controlling spending in a pre-paid Internet card. In a preferred embodiment of the invention, if a service is not provided and/or if the quality of the service is not sufficient, part or all of the costs involved may be refunded. Alternatively or additionally, a discount on access to the Internet and/or to certain sites may be provided this discount may be provided on request. The identification of the request may be included in an advertisement, so that readers of the advertisement may know to request the discount. Alternatively or additionally, a discount may be provided responsive to a user providing personal information and/or responsive to the personal information. Alternatively or additionally, additional “bonus” credit may be assigned to a card and/or a different rate may be used, responsive to a user agreeing to view advertising, visiting of certain sites accepting other promotions, using certain services and/or responding to questionnaires. It should be noted that varying the cost of Internet access responsive to a supplied quality of service can be especially important in pre-paid cards, where the user can be anonymous and the service provider is limited in the ways by which he can compensate a user for reduced quality. Additionally, the user is limited in the control he has over card expenditures. Quality-related costs are one way of the user controlling the life of the pre-paid account. Thus, a methodology is provided for an interaction between the card user and the Internet, possibly simplifying or eliminating the exchange of moneys, of bill generation, payment tracking and/or of risk taking by either of user or the service provider of an incompatible partner. However, in some embodiments of the invention, quality of service responsive billing may be applied to other methods of billing for Internet access and/or services, besides pre-paid methods.

Alternatively or additionally, different sites may have different access costs associated therewith. For example, viewing CNN may cost $1 per hour while viewing Microsoft's home page may cost $0.5 per hour. This cost differential may be maintained even if the site owners do not charge for visiting their site. In a preferred embodiment of the invention, a user can control spending from his card, preferably interactively. In one example, a user can trade off a connection rate, a connection speed, a quality of graphics to transmit, number, type and/or complexity of advertisements and promotions and/or the types of sites which may be accessed with a rate and/or a charge schedule. Alternatively or additionally, an indication may be displayed to a user prior to his spending credit, for example by indicating costs for a site and/or for a service. Thus, in a preferred embodiment of the invention, a user can OK any or all deduction from the card. Possibly, only costs above a certain amount, or of a certain type, are presented to a user for approval. In some cases, the service may be provided and if the user disapproves of the cost, some or all the sum refunded.

Some services may require payment only for a first use (in an Internet session) and/or a reduced amount at subsequent uses. Alternatively or additionally, some services which require payment may be paid by a card provider instead of by a user.

Another aspect of some preferred embodiments of the invention relate to providing an electronic persona, especially useful for a user which uses pre-paid Internet access. Such an electronic persona preferably includes one or more of identifying information, an e-mail account, storage space and configuration files to be used by certain software tools. In a preferred embodiment of the invention, when a user connects to an Internet from any location, using any computer and/or any service provider, such a user may simply and quickly set up his computer to operate in a manner convenient to him. For example, automatically setting up e-mail retrieval and configuration of personalization of word processors.

As used herein, a virtual or electronic personality includes both a static part (“persona”) and a dynamic part (“mood”). Technically speaking, both a mood and a persona may have a similar structure: preferences, weights and other aspects as described below. However, in a preferred embodiment of the invention, a persona is used to define a steady state personality which varies slowly, if at all. A mood is preferably used to emulate an instantaneous condition. In a preferred embodiment of the invention, the persona is defined as a structure and the mood defines changes in the structure, especially functional changes. For example, a “meticulous” persona which always desires complete downloads of images, may be modified by a “rush” mood, so that instantaneously it does not require complete downloads. In the applications described herein in which a persona is suggested, a mood may be provided as well or even instead of the persona, in accordance with some preferred embodiments of the invention.

As can be appreciated, the identifying information of the electronic persona may not be the same as the true identifying information of the user, thus providing the user with an ability to anonymously access the Internet.

In a preferred embodiment of the invention, electronic persona are provided in conjunction with Internet-access “telephone” booths and/or connection centers, for example at conferences. Such a booth preferably includes a general purpose computer having Internet access and including a plurality of software titles. In some cases, the booths may contain only a computer, without Internet access.

In a preferred embodiment of the invention, the information downloaded from the Internet in association with an electronic persona may include information for speaker-dependent voice control.

In a preferred embodiment of the invention, an electronic persona may operate differently and/or provide different access limitations responsive to an identification of a computer from which the persona logs on.

An aspect of some preferred embodiments of the invention relates to using such a persona as an aid in constructing and/or maintaining a WWW presence, for example a WWW site. In a preferred embodiment of the invention, a WWW site is automatically constructed for a user, responsive to a persona. Alternatively or additionally, the site modifies its content and/or presentation responsive to an instantaneous mood and/or persona of the user.

An aspect of some preferred embodiments of the invention relates to using a URL address field of a browser for entering commands. These commands may be entered instead of a standard URL, in addition to a standard URL (preferably as a postfix, but possibly as a prefix) or in addition to a non-standard URL or an indication of a URL which a user desires to view. Although a rigorous command language may be preferred, in some preferred embodiments of the invention a free form or even a natural language command interface is provided. These commands may be executed on the local computer, on a remote computer or on a combination of both computers. Alternatively or additionally, the results of the action may be presented as a “result” WWW page on the graphical display area of the browser. This page may be generated remotely or locally. In some cases, the commands may affect local data and/or remote data. In a preferred embodiment of the invention, the parsing, textual analysis and/or execution of the commends is affected by the virtual personality of the user, for example, the meaning of a word depending on the mood. Alternatively or additionally, the commands may refer to WWW pages or other Internet objects currently or previously accessed by the browser. Alternatively or additionally, the commands may refer to objects being manipulated by other software on the current or remote computers. One example of a command is “copy the current word file to my diskette and to Robert's computer”. Possibly, a command may be implicit. For example, a form may be filled in based on what a user enters in the URL line. In one example, a user enters an email address, causing an e-mail program (or a suitable WWW page) comes up with the address of the recipient filled in. in another example, if a user enters a telephone number, a form appears for sending a text message to the telephone, with the address already filled in. In the explicit case, a user will modify the data with a command, for example, “send a text message to 054-540540” or “text 054-540540”.

The command may be recognized as such in many ways, for example as described in the PCT applications incorporated herein. In a preferred embodiment of the invention, the browser is modified, possibly using a plug-in or a patch, to include code which first checks the entered text to see if it is a URL and if not, parses it as a command.

An aspect of some preferred embodiments of the invention relates to prepayment of advertisement costs. In a preferred embodiment of the invention, an advertiser, especially a small advertiser, can purchase a certain number of exposures or other advertising units. This purchase may be anonymous and/or may allow the advertiser to select between a large variety of advertising service providers. As the advertising units are used up, the account is decremented. Preferably, the advertiser can control where and/or how the advertisements are placed and/or their contents, the controlling preferably being done via the Internet.

Another aspect of some preferred embodiments of the invention relates to freedom of selection of an ISP. In a preferred embodiment of the invention, when a user connects up, the connection utilizes an anonymous card number and not a user identification. Thus, the actual connection to the Internet may utilize any local service provider. In a preferred embodiment of the invention, a card provider leases a certain number of “Internet connections” from local service providers and provides connection to the Internet, utilizing the modems and/or communication services of the local providers. This enables the card provider to purchase the “Internet connections” at a reduced rate.

Another aspect of some preferred embodiments of the invention relates to situations when the access time associated with a pre-paid card is used up. In a preferred embodiment of the invention, the connection is not terminated when the access time is up. Rather, the connection speed is slowed down and/or the connection quality is otherwise reduced so that further connection is not convenient. However, a user is preferably never cut off in a middle of an activity. Additionally or alternatively, a time remaining indicator may be display, preferably constantly to a user. Such an indicator may be created, for example, using a resident program, by modifying a WWW browser, by modifying a socket driver and/or by modifying WWW pages viewed by the user. Additionally or alternatively, a special “vital statistics” page may be available for the user. Additionally or alternatively, a warning may be displayed, for example as a banner, when the pre-paid access time is running down.

In a preferred embodiment of the invention, an empty pre-paid card may still be used to access the Internet, at reduced quality and/or limited to a site where additional access time may be purchased.

In a preferred embodiment of the invention, a card may be recharged, either by one of the access bonuses described above or by purchasing more time, for example using another pre-paid card, an on-line bank account and/or by credit card.

In a preferred embodiment of the invention, when a user uses a new pre-paid card instead of an old one, the user can associate the same electronic persona(s) associated with the old card, with the new card. Thus, the transition between cards can be seamless.

There is thus provided in accordance with a preferred embodiment of the invention a method of configuring a computer, comprising:
connecting to an Internet, using an arbitrary computer;
downloading from the Internet a persona; and
automatically updating the arbitrary computer using the persona, to be configured per a user's desire.

Preferably, automatically updating comprises automatically updating an e-mail address in an e-mail program on the arbitrary computer.

There is also provided in accordance with a preferred embodiment of the invention, a method of Internet access comprising:
connecting to an Internet, wherein said access is charged to a pre-paid account;
purchasing a service on the Internet, using the pre-paid account for payment; and
receiving a refund, to said pre-paid account, for the purchase if the service quality is not satisfactory.

Preferably, said service comprises a search and wherein said receiving a refund comprises automatically determining that the search failed.

There is also provided in accordance with a preferred embodiment of the invention, a method of maintaining pre-paid account, comprising:
providing a first pre-paid account, associated with a pre-paid Internet access card;
providing a second pre-paid card; and
transferring at least a part of a balance between the first and second cards.

There is also provided in accordance with a preferred embodiment of the invention, a method of Internet access, comprising:
detecting a connection request;
automatically selecting an ISP (Internet service provider) for the connection; and
performing the connection using the automatically selected ISP.

There is also provided in accordance with a preferred embodiment of the invention, a method of Internet connection, comprising:
dialing up an Internet access number, to start a session;
selecting an ISP after said dialing;
indicating said selected ISP during said session; and
connecting to the Internet, using said ISP.

Preferably, the method comprises automatically presenting to a user a selection of suitable ISPs.

Alternatively or additionally, said session is not an Internet session.

There is also provided in accordance with a preferred embodiment of the invention, a method of Internet service purchasing, comprising:
connecting to an Internet using a pre-paid account to pay for Internet access;
while connected to the Internet, ordering a service from a service provider; and
settling a bill for said service using said pre-paid account.

Preferably, said Internet connection is mediated by a pre-paid server and wherein said pre-paid server transfers funds to settle said bill.

There is also provided in accordance with a preferred embodiment of the invention, a method of pre-paid Internet access, comprising:
purchasing a pre-paid account;
accessing an Internet using said prepaid account, which access deducts from a balance of said account; and
performing one or more activities while connected to said Internet, which activities increase said balance.

Preferably, said activities comprise accessing a particular site. Alternatively or additionally, said activities comprise replying to a questionnaire.

There is also provided in accordance with a preferred embodiment of the invention, a method of Internet billing, comprising:
connecting to an Internet via a cost server;
accessing a plurality of sites via said cost server, without manually entering a password; and
being debited at a different rate for each accessed site.

Preferably, said Internet is accessed using a pre-paid Internet account.

There is also provided in accordance with a preferred embodiment of the invention, a method of Internet access, comprising:
connecting to an Internet using a pre-paid access account;
performing various activities while connected to said Internet, some of which activities generate deductions form said account;
viewing and authorizing at least one of said deductions, prior to its being made.

There is also provided in accordance with a preferred embodiment of the invention, a method of Internet access, comprising:
connecting to an Internet using a pre-paid access card; and
controlling access cost by selecting a connection configuration for the connection, wherein said connection configuration comprises at least one tradeoff between service and cost.

There is also provided in accordance with a preferred embodiment of the invention, a method of pre-paid Internet access, comprising:
accessing an Internet using a prepaid account, which access deducts from a balance of said account; and
performing one or more activities while connected to said Internet, which activities incidentally modify said balance additionally to said accessing, which activities are other than a requesting by an accessor of said account to transfer funds to said account from another account.

Preferably, said one or more activities increase said balance. Preferably, said one or more activities comprise accessing a particular site. Alternatively or additionally, said one or more activities comprise replying to a questionnaire. Alternatively or additionally, said one or more activities comprise providing personal identifying information. Alternatively or additionally, said one or more activities comprise requesting a service and wherein said balance is increased responsive to said service not being performed in a satisfactory manner. Preferably, the method comprises automatically determining, using a computer, if said service is performed satisfactory. Preferably, said service comprises a search and wherein satisfactory service comprises receiving suitable search results.

In a preferred embodiment of the invention, said one or more activities comprise viewing an advertisement.

In a preferred embodiment of the invention, said one or more activities decrease said balance. Preferably, said one or more activities comprise purchasing a physical item on the Internet. Alternatively or additionally, said one or more activities comprise purchasing a service on the Internet. Alternatively or additionally, said one or more activities comprise downloading software. Alternatively or additionally, said one or more activities comprise posting an advertisement. Alternatively or additionally, said one or more activities comprise retrieving information from an information providing service.

In a preferred embodiment of the invention, an accsessor of said Internet using said account is queried for conformation before at least one of said activities cause a charge deduction.

In a preferred embodiment of the invention, said Internet connection is mediated by a pre-paid server and wherein said pre-paid server transfers funds to pay for at least one of said one or more activities.

In a preferred embodiment of the invention, said one or more activities include activities which increase said balance and activities which decrease said balance and wherein said increasing activities and said decreasing activities cancel each other out, at least in part. Alternatively or additionally, said balance is constrained to remain positive. Alternatively, said balance is allowed to become negative.

In a preferred embodiment of the invention, a deduction responsive to said access is dependent on a quality of service of said connection. Preferably, said quality of service comprises a bandwidth. Alternatively or additionally, said quality of service comprises an response time. Alternatively or additionally, said quality of service comprises an image quality. Alternatively or additionally, said quality of service comprises an measure of advertising included in said Internet access. Alternatively or additionally, said quality of service comprises a predefined quality of service. Alternatively or additionally, said quality of service comprises an actual quality of service.

In a preferred embodiment of the invention, said access to said Internet is anonymous. Alternatively, a user name is associated with said account after said account is used for a first time.

In a preferred embodiment of the invention, an e-mail address is associated with said account. Alternatively or additionally, the method comprises presenting a balance of said account to said user, while said user performs said one or more activities. Alternatively or additionally, the method comprises limiting access to said Internet responsive to limitation information associated with said account. Preferably, said information is associated with said account after said account is first used.

In a preferred embodiment of the invention, said account has a virtual personality associated therewith. Preferably, said accessing is modified responsive to said virtual personality.

There is also provided in accordance with a preferred embodiment of the invention, apparatus comprising:
a computer; and
a storage media having software stored thereon, wherein said software supports said accessing and said modifying said account as described above.

There is also provided in accordance with a preferred embodiment of the invention, a method of maintaining pre-paid account, comprising:
providing a first pre-paid Internet access account associated with personalized information;
providing a second pre-paid card; and
transferring at least a part of a balance between the account and the card.

There is also provided in accordance with a preferred embodiment of the invention, a method of Internet access, comprising:
detecting a connection request, by a connection server;
automatically selecting, by the connection server, an ISP (Internet Service Provider), from a plurality of available providers, for the connection; and
performing the connection using the automatically selected ISP. Preferably, said connection server is implemented on a computer used to connect to the Internet. Alternatively or additionally, said connection server is implemented on a computer other than one used to connect to the Internet.

There is also provided in accordance with a preferred embodiment of the invention, a method of Internet connection, comprising:
dialing up an Internet access number, to start a session;
selecting an ISP (Internet Service Provider) after said dialing;
indicating said selected ISP during said session; and
connecting to the Internet after said indicating, using said selected ISP. Preferably, the method comprises automatically presenting, by a connection server, to a user a selection of suitable ISPS, for said selecting. Alternatively or additionally, said session is not an Internet session.

There is also provided in accordance with a preferred embodiment of the invention, a method of Internet billing, comprising:
connecting to an Internet via a cost server;
accessing a plurality of Internet sites via said cost server, using an Internet interaction protocol, which access does not require additional actions beyond selecting a URL (Uniform resource locator); and
generating a debit, which debit accumulates charges at a different rate for each accessed site. Preferably, said Internet is accessed using a pre-paid Internet account, which account is debited using said debit. Alternatively or additionally, the method comprises presenting an indication responsive to said debit to said user during said access.

In a preferred embodiment of the invention, said cost-server is connected to via the Internet.

There is also provided in accordance with a preferred embodiment of the invention, a method of pre-paid access, comprising:
providing a pre-paid account;
connecting to an Internet, debiting said account for said connection at a debit rate; and
modifying said rate responsive to a quality of service for said connection. Preferably, said quality of service is requested by a user of said account. Alternatively or additionally, said quality of service is determined based on parameters of the actual connection.

There is also provided in accordance with a preferred embodiment of the invention, a method of configuring a computer, comprising:
connecting to an Internet, using an arbitrary computer;
downloading from the Internet a virtual personality; and
automatically updating the arbitrary computer using the virtual personality, to be configured as indicated by said personality. Preferably, automatically updating comprises automatically updating a source e-mail address in an e-mail program on the arbitrary computer. Alternatively or additionally, automatically updating comprises configuring production software program on said computer responsive to said download. Preferably, said production software comprises a word processor.

There is also provided in accordance with a preferred embodiment of the invention, a method of placing an advertisement using a pre-paid advertising account, comprising:
slotting advertisements in available advertising slots in an Internet;
charging said slotting to said pre-paid account; and
controlling, by a user, an actual presentation of said advertising responsive to a real-time status of said account. Preferably, said user chooses said slots. Alternatively or additionally, said controlling comprises modifying a targeting of said advertisements. Alternatively or additionally, said controlling comprises modifying an exposure rate of said advertisements.

There is also provided in accordance with a preferred embodiment of the invention, software for WWW site construction, comprising:
a user input unit for receiving requests from a user;
a personality receiving unit for receiving a virtual personality associated with said user;
a selection display unit for selecting options to said user, which selections are displayed responsive to said received virtual personality, and which user input is used to select from said selections; and
a site constructor which generates a portion of said site responsive to selections by a user.

There is also provided in accordance with a preferred embodiment of the invention, a method of WWW site maintenance, comprising:
determining a current virtual personality of a user associated with a particular WWW site; and
modifying a presentation of said site responsive to said determined virtual personality. Preferably, said modifying comprises modifying display files. Alternatively or additionally, said modifying comprises modifying a behavior of active components associated with said site. Alternatively or additionally, said modifying comprises replacing display files.

There is also provided in accordance with a preferred embodiment of the invention, a method of commanding a computer to perform an action, comprising:
providing an Internet browser comprising at least an address entering portion and a page display portion;
entering at least an indication of a command, which command does not meet standard URL definitions, into said address portion; and
executing said command, which command is other than a command to retrieve or connect to a URL. Preferably, said indication comprises an explicit command. Alternatively, said indication comprises an implicit command. Alternatively or additionally, said command modifies a file on a computer used for said browser. Alternatively or additionally, said command modifies a file on a computer remote form the said browser.

There is also provided in accordance with a preferred embodiment of the invention, a method of manipulating a pre-paid card, comprising:
receiving an anonymous pre-paid account;
associating a personal information with said account; and
interacting with an Internet using said account, which interaction is modified by said personal information. Preferably, said personal information comprises a user identification. Alternatively or additionally, said personal information comprises at least one limitation on said card. Preferably, said at least one limitation comprises a limitation on cost expenditure using said account. Alternatively or additionally, said at least one limitation comprises a limitation on accessing certain sites.

In a preferred embodiment of the invention, said personal information comprises a virtual personality. Alternatively or additionally, said interaction modifies a balance of said account. Alternatively or additionally, said personal information comprises a storage location on a computer connected to said Internet. Alternatively or additionally, said interaction comprises accessing the Internet. Alternatively or additionally, said pre-paid account is limited to purchasing information. Alternatively, said pre-paid account is limited to purchasing advertising.

There is also provided in accordance with a preferred embodiment of the invention, a method of calculating a pre-paid account balance, comprising:
deducting from said account responsive to activities charged to said account, which activities include an interaction with an Internet;
determining a quality of said activity; and
adding to said account responsive to said determined quality, if said quality is deemed unsatisfactory.

There is also provided in accordance with a preferred embodiment of the invention, a method of doing business, comprising:
producing a plurality of pre-paid cards for interacting with the Internet; and
selling said cards to individual customers. Preferably, said cards are associated with accounts for accessing the Internet. Alternatively or additionally, said cards are associated with accounts for purchasing advertisements. Alternatively or additionally, said cards are associated with accounts for purchasing information.

There is also provided in accordance with a preferred embodiment of the invention, a configurable computer, comprising:
a computer having production software stored in association therewith;
software loaded on said computer, which software configures said production software to match a user, responsive to personalization information provided by said user;
usage tracking software for charging for the use of said computer; and
a data port from providing said personalization information by said user. Preferably, said data port comprises an Internet connection. Alternatively or additionally, said data port comprises a connection to a portable computer.

### BRIEF DESCRIPTION OF THE DRAWINGS

The present invention will be more clearly understood from the following detailed description of preferred embodiments of the invention, together with the attached figures, in which:

FIG. 1 illustrates a configuration of a pre-paid Internet connection service, in accordance with a preferred embodiment of the invention;

FIG. 2A is a flowchart of a process for connecting to an Internet using a pre-paid connection service, in accordance with a preferred embodiment of the invention;

FIG. 2B is a flowchart of an alternative process for connecting to an Internet using a pre-paid connection service, in accordance with another preferred embodiment of the invention;

FIG. 3 illustrates a configuration for providing an electronic persona to an arbitrary connection, in accordance with a preferred embodiment of the invention;

FIG. 4 is a flowchart of a process for providing an electronic persona, in accordance with a preferred embodiment of the invention; and

FIG. 5 is a flowchart of a process for ISP-independent Internet connection, in accordance with a preferred embodiment of the invention.

### DETAILED DESCRIPTION OF PREFERRED EMBODIMENTS

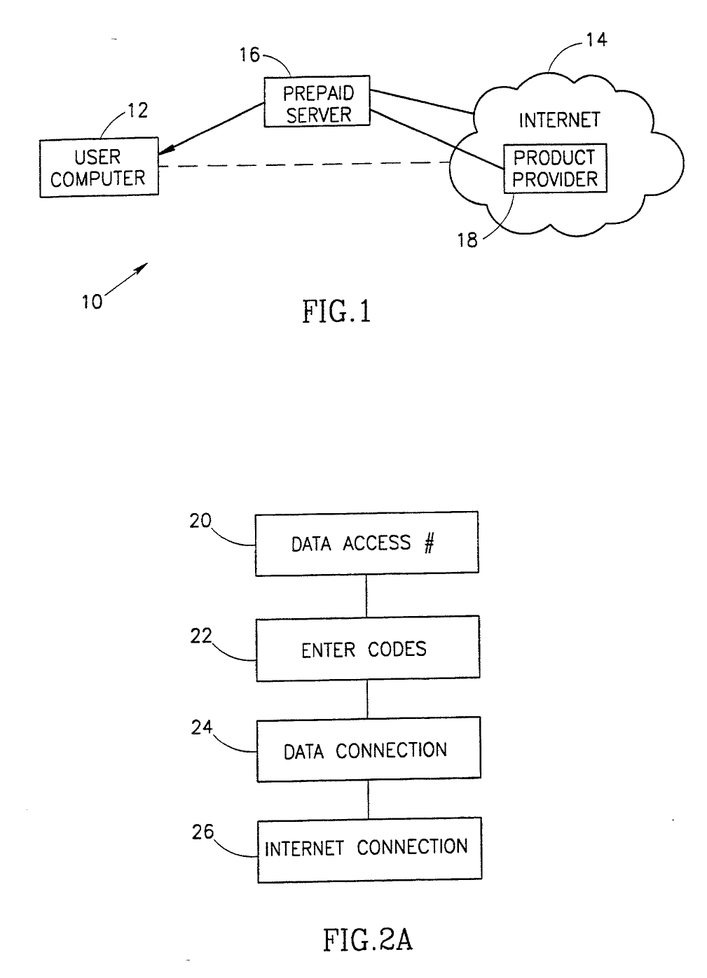

FIG. 1 illustrates a configuration of a pre-paid Internet connection service 10, in accordance with a preferred embodiment of the invention. When a user computer 12 is to be connected to an Internet 14, the connection is preferably meditated by a pre-paid server 16, which manages the act of connecting user 12 to Internet 14 and also, preferably, acts related to billing the user for the Internet access. Once user 12 is connected to Internet 14, the connection may pass through pre-paid server 16. Alternatively or additionally, the set-up connection may be direct between user 12 and Internet 14.

As opposed to a standard connection, for example from a home or work computer to a local ISP, a pre-paid connection is useful when a user is on the go and needs to connect from a remote location. In some cases, such a user will have a laptop, but no local ISP access number. In other cases, such a user will not have a laptop either. Additionally, a pre-paid connection is useful if the financier of user 12 desires some measure of control on the amount and/or type of Internet access. In one example, a parent will desire to limit the amount of access time for a child. By providing the child with a pre-paid Internet access card, the parent can limit the amount of money spent on access and the amount of money spent on purchasing services and/or products on the Internet. Additionally, as described below, pre-paid server 16 may be used to limit the access of the child to certain sites. It should be noted that this control is possible with a minimum amount of effort by the parent and a greater feeling of freedom by the child.

In a similar manner, a worker may be provided with an Internet access card, for work-related Internet access. Such a card may be limited to accessing the workplace. Additionally, such a card provides a small amount of spending cash, for such a worker to use, if necessary.

Alternatively or additionally, a card may be limited to work with certain services. In one example, a card may be constrained to work with a certain WWW address finder, for example as described in Israeli application number 123,129, filed on 30 Jan. 1998, now PCT application PCT/IL99/00055, the disclosures of which are incorporated herein by reference. The address finder described in the above application allows a user to enter information associated with an address in a free-form format and/or substantially any language. The described WWW page is then directly displayed to the user. Alternatively or additionally, the card may be used to charge the user for the use of the address finder. Alternatively or additionally, the card may simply allow the user to access such services.

In another example, a pre-paid access card may be provided as a promotion. Generally, accessing the Internet with such a card will force a user to view a certain WWW site, answer questions and/or view advertising material, before he can use the Internet access for other uses. A work place may use such features to force a worker to view company and/or private news. In another example, a promotion card may be restricted to a certain WWW site, however, some of the pre-paid amount may be available for sampling services offered by the site.

In a preferred embodiment of the invention, purchasing of services and/or products from an online product provider 18 is meditated by pre-paid server 16. Preferably, provider 18 bills the pre-paid server directly and the pre-paid card is debited by the amount (possibly including a surcharge). Preferably, the user is not required to enter and special billing information, beyond ordering the product. Then, product provider 18 obtains any required information directly from pre-paid server 16 and/or by reading the required information (e.g. a cookie) from user computer 12. Thus, in a preferred embodiment of the invention, pre-paid server 16 handles access and/or billing issues, allowing a user freedom from remembering account details and passwords.

Alternatively, a user may be required to actively present the pre-paid card identification number to product provider 18. Alternatively or additionally, a electronic bank account and/or credit account may be associated with the pre-paid card and be charged for the purchase. Alternatively or additionally, in some cases product provider 18 may be a part of-, integrated with- and/or associated with- pre-paid server 16, for example if the product provider is an information server, for example one which provides Internet address finding services.

In a preferred embodiment of the invention, the pre-paid account may be used for the purchase of information, especially agate information, such as stock quotes and weather. Possibly, all or some of the prepared account (e.g., a sub-account) may be dedicated to a particular type, class or grouping of information. In one example, a user may pre-purchase 100 stock-quote updates. Possibly, the pre-paid account is not anonymous. Rather, it may be used by a financier (e.g., a parent, a company) to track how a user is pending the account.

As can be appreciated, any amount pre-paid with the card may be used for purposes other than Internet access. For example, the card may be used to transfer funds to a second card or an electronic bank account. In a preferred embodiment of the invention, a user can split a balance of one card between several cards. Alternatively or additionally, the Internet access card may be combined with a long distance calling card. Alternatively or additionally, the pre-paid Internet access card may be used for paying for Internet telephony.

In a preferred embodiment of the invention, the card is provided as a promotion, for example, by a business, an Internet service provider (ISP) and/or a long-distance telephone company. Alternatively, such a card may be purchased, for example at a neighborhood grocery. It should be noted that the card itself is usually only a conveyance medium. Thus, the codes associated with a card may be purchased and/or provided by an electronic media, such as a diskette and/or by e-mail. In a preferred embodiment of the invention where the card comprises computer readable media, the current balance may be downloaded to the card at the end of any session and/or during such a session.

A pre-paid card may be a one time card. Once the access time is used up, the card can be disposed of. Alternatively or additionally, the card may have an access account associated therewith, which account can be replenished. In one example the card is replenished by credit card transfer, for example by fax, e-mail or by calling a 1-800 number. Alternatively or additionally, the card is automatically replenished and a bill is mailed and/or e-mailed to a user. Alternatively or additionally, the card is replenished by calling a “900” number and being billed by the telephone company. Alternatively or additionally, the card is replenished from another pre-paid card, possibly of a different type, such as a long distance calling card. Alternatively or additionally, the card may be replenished using an electronic banking account. Alternatively or additionally, the card may be replenished by an ISP. Alternatively or additionally, as described below, a card may be replenished by the user performing certain activities.

In a preferred embodiment of the invention, the balance in a pre-paid card is maintained as a plurality of discrete amount elements, each of which may be used or not. A ID and/or a digital signature may be associated with each of the amount elements, so that it is possible to trace their use and/or guarantee that they are not reused and/or replicated. In one preferred embodiment of the invention, the amount elements are all the same size. Alternatively or additionally, several sizes are provided, for example 5c, 10c, 25c, 1$, 5$, 50$ and 100$. In a preferred embodiment of the invention, when a user pays a product provider 18, a plurality of amount elements are used to pay for the product. Preferably, the number of elements is minimized, by appropriately selecting the amount denominations. Alternatively or additionally, small amounts may be easily paid, for example by using a small denomination. The payment may be transferred immediately to product provider 18. Alternatively or additionally, the payment is transferred when several small payments accumulate. In a preferred embodiment of the invention, a user may convert elements of one denomination to elements of another denomination. In embodiments where the card comprises a storage media, the IDs of the elements are preferably stored on the card.

In a preferred embodiment of the invention, the payment is initiated by pre-paid server 16, so that there is less of a danger that product provider 18 is attempting to illegally acquire payment. Preferably, the payment requires a connection using the card by the user, so that there is less of a danger that the user is attempting to illegally use the card. Even if a user has illegally obtained the card information, the user is required to connect using the card (preferably not an instantaneous process), possibly requiring a new telephone connection, so thievery is more difficult. Additionally or alternatively, the amount of money associated with a prepaid card is preferably small, so that even if the card is stolen, the damage is minimal.

In a preferred embodiment of the invention, product provider 18 returns an indication that the payment was sufficient. Alternatively or additionally, the assurance of pre-paid server 16 is enough, so that the user can receive the service, even if the payment has not yet been transferred. Pre-paid server 16 preferably debits the pre-paid card immediately. If the amount debited was larger than required or if the payment amount is not known exactly in advance, pre-paid server 16 preferably refunds the pre-paid card after the complete amount is known.

In a preferred embodiment of the invention, the card balance is maintained as Internet access time. Alternatively or additionally, the card balance may be linked to one or more currencies, for example, US $, Japanese yen, German DM or other currencies. In a preferred embodiment of the invention, portions of the card balance may be each linked to a different currency, for example, one third of the card being linked to access time, one half to US $ and the balance to German DM. Transferring between the linking currencies is preferably charged for by the pre-paid server. In a preferred embodiment of the invention, an order of utilization for each card portion is indicated by the user and/or automatically assigned by pre-paid server 16, for example based on size (e.g. largest first). In-a preferred embodiment of the invention, when one portion is used up, the next in line is used. Alternatively or additionally, the portion to be used is selected based on the transaction, for example, based on a currency preferred by product provider 18.

In a preferred embodiment of the invention, a positive interest may be automatically provided for any unused balance. Alternatively, positive interest may require an special request by a user, for example in response to a request freeze the card for a minimum period of time. Alternatively or additionally, the interest may be provided only on an part of the balance which is above the starting balance, for example that accrued using bonus activities (described below). Alternatively or additionally, a negative interest may be applied. Interest is preferably applied using a temporally sliding scale, for example, beginning decrementing the card balance only if three months have passed since the card was purchased and/or refilled.

In a preferred embodiment of the invention, pre-paid server 16 includes a clearinghouse for converting and transferring finds between the various types of Internet and non-Internet electronic money, and especially between pre-paid cards.

In a preferred embodiment of the invention, a pre-paid card is used for gambling. A person purchases a pre-paid card, possibly one which is dedicated to a gambling site or a consortium of gambling sites. When the person loses money, the money is removed from the card account. When the person wins, the winnings are preferably added to the card account. Alternatively or additionally, winnings may be transferred to an electronic or regular bank account or a check may be printed and mailed, preferably at a user's stipulation. Thus, a user may maintain anonymity while gambling and/or limit his losses to an acceptable, predetermined amount.

In a preferred embodiment of the invention, a user can recharge the pre-paid card, if the gambling losses use up the card balance. In a preferred embodiment of the invention, transfer of funds to (or from) a card may be performed at the end of a gambling session. Alternatively or additionally, the funds, especially losses, are transferred in real-time. The fund transfer is preferably handled by the pre-paid server, which may also broker the gambling site.

In a preferred embodiment of the invention, a gambling game may include a zero-sum type game where one player's losses form another player's winnings. In a preferred embodiment of the invention, the relevant funds are transferred directly from the pre-paid card of the loser to the pre-paid card of the winner. Preferably, some of the winnings are directly transferred to the gambling site owner. Alternatively or additionally, payment to the site owner is made at entry to the game. Alternatively or additionally, in betting game for example, the bet funds are transferred to a bet holding account and then transferred to the winners.

In many cases, gambling winnings are taxable. In a preferred embodiment of the invention, the prepaid server and/or the gambling site owner deduct a tax portion of any winnings and transfer them to a tax authority. Thus, a user may maintain his anonymity while still complying with a requirement to pay taxes. Alternatively or additionally, the pre-paid server may provide an indication to the tax authorities of the gambler's identity, preferably without the gambling site owners knowledge.

In a preferred embodiment of the invention, different portions of the balance of the pre-paid card account or possibly a different type of electronic payment means, such as an electronic banking account or a credit card may be associated with different tax designations, for example, a gambling winnings portion, a stock winnings portion and a capital gains winnings portion. These portions may remain in the card balance, for example in case they are offset by losses. However, a user may remain aware of which portion of his account is owed as taxes. Alternatively or additionally, a user may be unable to withdraw these sums, expect for legally allowed uses, such as to offset winnings and losses. Preferably, when money is transferred into an account a designation of the tax status and/or other information may be associated with the money, for example, gambling winnings receive one designation and money to refill up the account receive a second designation. Alternatively or additionally, to tax designations, the information may comprises a source of the money. Preferably, when a user expends money from the account, the user is prompted to indicate which money type to use. Alternatively or additionally, a default money type is used.

Alternatively or additionally to tracking taxes and money sources, other book-keeping functions may be integrated into the pre-paid card account. In a preferred embodiment of the invention, the pre-paid provider tracks what uses the money was put to, for example, which services were bought and/or which products were received. In a preferred embodiment of the invention, the expenditure tracking is integrated with receipt and/or use tracking, for example to determine that a service paid for was actually received and/or the amount that the service was used. Some of this information may be automatically available from the service provider, for example as part of the sales transaction. Alternatively or additionally, this information may be entered by a user, for example using a dedicated program and/or a dedicated WWW page. Alternatively or additionally, the information may be available by tracking which services a user uses and/or other information available by tracking the users surfing and/or computer usage habits. Thus, a user can track his expenditure patterns and/or glean various statistics. Alternatively or additionally, a user may define limitations on certain expenditure patterns, for example, large sums or maximal sums per service. When a user reaches such a limitation, the user may be alerted, allowed to bypass the alert and/or informed that the transaction cannot proceed. Preferably, this book-keeping information may be downloaded to a personal book-keeping program. Alternatively or additionally, the book-keeping information is maintained as part of the persona.

One important issue with pre-paid Internet cards and with Internet access in general is controlling the access cost. In a preferred embodiment of the invention, this issue is addressed by:
(a) viewing current and expected costs;
(b) providing the ability to reducing future cost; and
(c) providing rebates and/or reduced rates and/or other bonuses in response to special activities.

In a preferred embodiment of the invention, a current state of a pre-paid Internet account is displayed to a user. Additionally, such a display may include a balance of an online banking account associated with the card and/or other information associated with the card and/or usage statistics. The relevant information is especially available in the embodiments where all interaction with the Internet is through pre-paid server 16. Preferably such a display is provided as a separate WWW page. Alternatively or additionally, the display is shown as part of a screen saver. Alternatively or additionally, the display is overlaid on a displayed WWW page. Alternatively or additionally, the information is displayed in a banner. Alternatively or additionally, the information is displayed instead of an advertisement. Alternatively or additionally, the information is accessed by a Java applet, which may be downloaded when the connection is initiated. Alternatively or additionally, the information is accessed by a browser (generally modified) and possibly displayed in a separate window. Alternatively or additionally, the information is accessed by a resident program. Alternatively or additionally, the information is accessed by a modified TCP/IP stack. The information may be displayed continuously. Alternatively or additionally, the information is displayed periodically. Alternatively or additionally, the information is displayed by request.

In a preferred embodiment of the invention, when the account reaches a critical low level, a special indication/warning is displayed to the user, for example using a banner or in a separate window. In one exemplary application, an account is decremented as it is used until it reaches near zero, when corrective action is required. Alternatively, the account is decremented at the beginning and/or end of each session and/or special transaction (e.g., purchase). It should be noted that a single account may include more than one sub-account, so that separate tracking of the sums in each sub account and/or provision for transferred amounts between sub-accounts, may be desirable.

In a preferred embodiment of the invention, when the account reaches zero, the Internet connection is not terminated. Rather, the quality of the connection is degraded to induce the user to buy more access time. Alternatively, the quality of the connection (and the rate) may be reduced, preferably gradually, as the account nears zero. In a preferred embodiment of the invention, reducing the quality comprises reducing connection speed, graphics quality, increasing number of advertisements, reducing response time and/or eliminating features and/or services such as bonuses, encryption of the connection and/or of selected data, automatic notification of e-mail and/or other messaging services.

In a preferred embodiment of the invention, not all sites are accessed at a same rate. Any of the following methods (or other methods as well) may be practiced, separately and/or in combination. First, different rate schedules may apply to different sites and/or services, for example: flat rate, rate per use, rate per number of page accesses, rate per download count, rate per download bandwidth, rate per new page accessed, rate per time, rate per bandwidth and/or data rate and/or rate schedules changing as a function of the number of access times and/or access periodicy and/or access latency. Second, different site may have different rates. Third, different users may have different rates and/or rate schedules. Fourth, specific sites may allow the accrual of bonus points, usually for promotion purposes. Such bonus points may also be accrued in response to viewing advertisements, answering questionnaires, filling questionnaires, responding to polls and/or surveys, receiving, reading and/or responding to e-mail announcements, providing personal information and/or other activities by the user. In a preferred embodiment of the invention, the number of bonus points depends on characteristics of responding, for example, response time to read and/or answer, length of answer, trustfulness of answer (by comparing questionnaires and/or responses to similar questions within a same questionnaire) and/or meaning completeness of answer (for example by checking that answers are English words and not gibberish and/or by feedback from a survey reviewer). In a preferred embodiment of the invention, such promotions, questionnaires and/or surveys may be limited in time, in number of respondents, in reaching a desired statistical significance of replies and/or by other time or content limits. Preferably, a persona which does not respond before the time is up does not receive any bonus point or only a minimum number thereof.

In a preferred embodiment of the invention, the user is prompted to perform such bonus activities, for example in an advertisement. Alternatively or additionally, the user must request these activities, for example using a code and/or WWW address indicated in an advertisement and/or promotional material. In a preferred embodiment of the invention, such bonus points may be accrued as access time. Alternatively or additionally, these bonus points have a limited utility, for example, towards using specific services and/or receiving gift products. Alternatively or additionally, the bonus points may also be used to provide feedback to promoters. Alternatively or additionally, the bonus points may be used towards increased functionality, for example, increased storage space, fewer advertisements, interest on pre-paid card balance, priority in receiving special offers, MailPush, Internet address finding services and/or other increases in quality and/or quantity of service for a same prepaid card.

Fifth, a user may receive a bonus points and/or a refund if a provided service did perform in a satisfactory manner. A refund may also include bonus points and/or a compensation for bad service. Alternatively or additionally, a refund may sometimes be for less than the whole amount. Preferably, the user requests the refund. Alternatively or additionally, the eligibility to a refund is detected automatically. Preferably, an automatic program in prepaid server 16 tracks automatic refunds in order to detect un-equitable use of the refund mechanism. In one example, a refund may be provided if a download is cut off in the middle. In another example, a refund may be provided if a search engine failed and/or if a user failed to find what he was looking for. Alternatively to the refund being provided to the same pre-paid card, the refund may be provided as a second pre-paid card and/or mailed to the user at an address of his choosing. Preferably, the mailing includes promotional material.

Alternatively or additionally, to the above methods of varying rates, rates may depend on the time of day. Alternatively or additionally, the rates may depend on available transmission bandwidth. Alternatively or additionally, the rates may depend on a difficulty of connecting to a site and/or on its popularity and/or on promotion rates and/or subsidies paid, for example, by the site owner. Alternatively or additionally, the above parameters may be determined on an instantaneous basis. Alternatively or additionally, they are determined on an average basis. Alternatively or additionally, they are pre-determined.

In a preferred embodiment of the invention, the rate schedule depends on a user agreeing to view advertisements. Alternatively or additionally, the rate may depend on the size of advertisement, e.g. a banner, shown or agreed to be viewed by a user. Size may be measured as absolute size. Alternatively or additionally, size is measured relative to a user's screen size and/or window size. Such user related information is preferably provided by the user's browser and/or by a resident program associated with the pre-paid service. Preferably, the advertisements are personalized by the pre-paid server 16 to the particular user. Preferably, the information required to personalize the advertisement is maintained in confidence by pre-paid server 16. Preferably, when the Internet access is through pre-paid server 16, each connection to a site may utilize a different user identification, so that the user's access remains secret. In one example, a user may maintain several electronic persona which are cycled by the pre-paid server and/or by the user's computer, so that it is more difficult to follow his surfing habits.

Alternatively or additionally to a deducting pre-paid card as described herein, a positive pre-paid account can be provided, in which account (or sub-account) the cost accrued by a user are accumulated to be offset by activities of the user. If the user does not off-set all of the accrued costs corrective action may be taken, for example, the account may be closed, the user may be sent a bill and/or the user may be directed to a site (or sites) where he can practice cost-deducting activities. The limit of the card may be the same for all cards, may be fixed when the card is created or may vary between cards and/or for a same card over time. The card limit may depend, for example on the promotion type, on the card user's habits (especially of paying back promptly, or to detect if a single user is using or abusing several such cards) and/or on the number of transactions processed through the card. The card may be purchased at a cost corresponding to the limit. Alternatively, a lower cost may be required, possibly the card being provided for free. Such a scheme has, in some embodiments of the invention, the advantage that it may be anonymous. Alternatively or additionally, like other pre-paid cards, the user can be targeted based on an identification of the user (possibly based on what the user allows to be stored on the card) and/or other card related information, such as where the user received the card. In an exemplary embodiment, a user accrues costs for accessing the Internet and purchasing agate information and then “pays” for the accrued costs by viewing targeted advertisements and/or filling out questionnaires.

Alternatively or additionally, the rate schedule may depend on a user requesting and/or receiving premium (e.g., high speed, high quality) service.

In a preferred embodiment of the invention, each WWW site may include a rate schedule. Alternatively or additionally, a central (or distributed) repository may include rate schedules and/or acceptable payment methods. Preferably, a WWW site will not allow connection and/or will allow only a reduced quality and/or time connection and/or will include more advertisements if the stated rates are not paid. In a preferred embodiment of the invention, the pre-paid server and/or a user's computer may communicate billing information to a WWW server which provides the WWW site. Preferably, the WWW server conducts any required financial transactions directly with the pre-paid server and/or electronic money providers. Preferably, the required financial transactional ability is embedded in the user's browser.

In a preferred embodiment of the invention, a user can tradeoff one or more of the above rate setting mechanisms against quality of service and/or other desires. Thus, a user can limit his spending. Alternatively or additionally, a user may set other spending limits, for example, limits on rates, per site cost, per hour spending, per product cost and/or limits on advertisement rate and/or content and/or combinations of the above. If any of these limits are exceeded and/or about to be exceeded, the connection to the WWW site may be terminated. Alternatively or additionally, the user is notified and further instructions are requested. The limits and/or imminent exceeding of them may be indicated to user's computer, especially a browser, to pre-paid server 16, to product provider 18, to a server of a WWW site and/or to electronic payment means, for example an electronic bank.

Alternatively or additionally, some or all outlays of money, access time and/or bonus points may require confirmation of permission from the user. Alternatively or additionally, only if such outlays exceed certain, preferably user predefined, limits.

In a preferred embodiment of the invention, pre-paid server 16 provides a WWW page at which rates and/or possible tradeoffs are listed. Alternatively or additionally, the server provides an interactive WWW page at which a user may set such tradeoffs. Alternatively or additionally to using a WWW page, a special purpose software may be provided to the user. Preferably, such software updates itself from the Internet with the latest offerings. Alternatively or additionally, a user may select tradeoff options and/or listen to rates using a telephone and/or an IVR (interactive Voice Response) system.

In a preferred embodiment of the invention, a user can select and/or change a trade-off or other cost affecting parameters substantially in real time. In one example, one or more controls and/or displays are added to the browser (by a local software) and/or to a WWW page (e.g., by pre-paid server 16, as a button, banner or advertisement), using which controls and/or displays a user can determine a current status of trade-offs and/or change them.

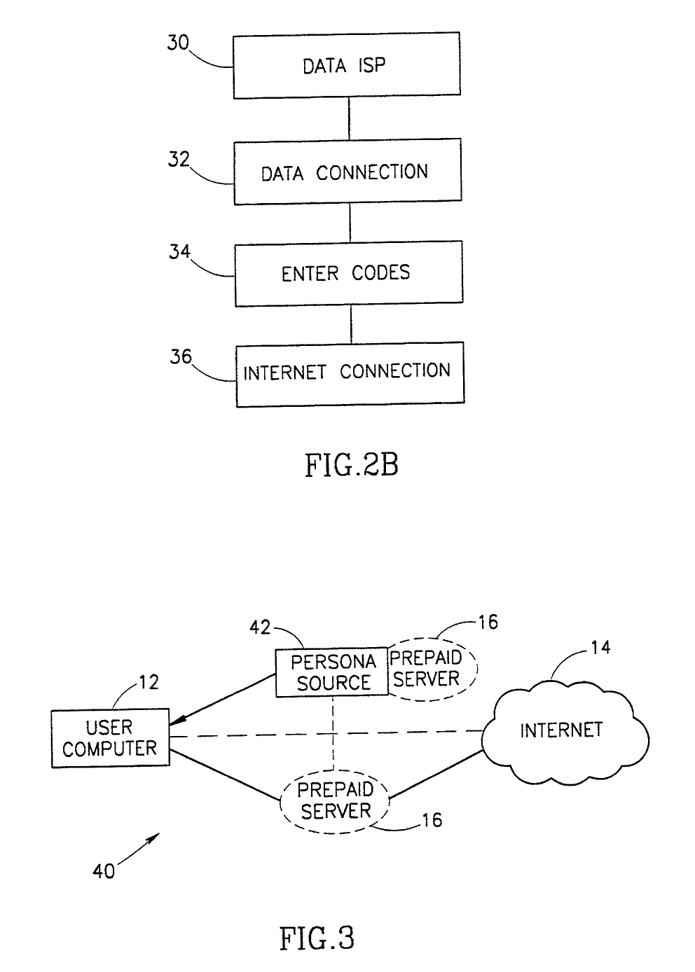

FIGS. 2A and 2B are flowcharts illustrating two methods of connecting to the Internet using a pre-paid Internet card. In a preferred embodiment of the invention, the connection process includes the following steps:
(a) acquiring card information;
(b) calling up an Internet provider and/or other services;
(c) connecting to the Internet using the card information;
(d) surfing the Internet, using e-mail and/or other Internet uses;
(e) if the access time is used up, purchase more time or a new card; and
(f) if Internet access if over for the time being, reconnecting at a later time with a balance of access time.

FIG. 2A is a flowchart of a process for connecting to an Internet using a pre-paid connection service, in accordance with a preferred embodiment of the invention. First, an access number is dialed (20). At this point, the established connection is NOT a data connection, or at least not a TCP/IP connection. Codes associated with the pre-paid card are preferably entered (22) and a data connection is established (24). Additional user information may be entered at this point and an Internet connection is then established (26). It should be appreciated that once the codes are entered (22), pre-paid server 16 has enough information to establish an Internet connection without any additional user intervention. Preferably the codes are entered using DTME dialing. Alternatively or additionally, at least some of the codes may be entered using voice entry. It should be appreciated that once some identifying information is available to pre-paid server 16, such as source telephone or card ID, speech identification can be made speaker-dependent. In a preferred embodiment of the invention, service announcements and/or one or more advertisements, especially advertisements referring to access discounts, may be sounded to the user while he is waiting for the Internet connection. It should be noted that the method of FIG. 2A does not necessarily require a keyboard for entering data.

FIG. 2B is a flowchart of an alternative process for connecting to an Internet using a pre-paid connection service, in accordance with another preferred embodiment of the invention. An ISP is dialed (30). Once a data connection is established (32), a user preferably enters access codes (34) and then an Internet connection is established (36). If a direct data connection, for example a LAN, is available, it may be possible to skip steps 30 and 32. Alternatively or additionally, to entering codes at before Internet connection. In a preferred embodiment of the invention, such codes may be required only after a user has viewed a promotion and/or after a short “free” connect time, which may be mandated by the pre-paid card.

In a preferred embodiment of the invention, the entire connection process from the dial-up until an Internet connection is established is performed by the user's computer without a need for user intervention. Preferably, the user enters the required access codes into the computer, prior to (or during) the connection process. In a preferred embodiment of the invention, a user may enter several access code sets, corresponding to several pre-paid cards, so the user's computer can switch from one to the next when access time is used up and/or to bypass access limitations. Alternatively or additionally, a user may provide and/or receive a single code which incorporates all the remaining time. In a preferred embodiment of the invention, when such a code is suggested by a user to pre-paid server 16 or when the code is transferred to the user by pre-paid server 16, the code is encrypted.

When a card runs out, the user may be limited to access sites at which the user can “recharge” the card. Alternatively or additionally, the user is prompted to see if he wants to store information that become associated with a card, for example an electronic persona, described next. Alternatively or additionally, a user can attempt to accumulate sufficient bonus points using the above described bonus techniques. Alternatively or additionally, a user is allowed to go into debit, at least a small amount. Preferably however, when a user is in debit some of his “possessions” may be frozen. In one example, a user cannot transfer a persona if the pre-paid card is in debit. In another example, a user cannot access a personal storage area or e-mail. In another example, a user can receive e-mail but cannot send it, or vice versa. In another example, if a user stays in debit, the pre-paid server may be allowed to provide identifying information to interested third parties, such as advertisers.

FIG. 3 illustrates a configuration 40 for providing an electronic persona to an arbitrary Internet connection, in accordance with a preferred embodiment of the invention. One advantage of connecting to the Internet using a pre-paid card is the possibility of anonymity. Conversely, in many cases a user will desire to maintain his “identity” even if connecting from different locations. In a preferred embodiment of the invention, when a user connects to the Internet using a pre-paid card, the user can utilize an electronic persona. One aspect of this persona is that it may be used to mask the true identity of the user. Another aspect of this persona is that a user may maintain the persona across ISPs, computers, connection sessions and/or connection location.

In a preferred embodiment of the invention, user computer 12 obtains an electronic persona from a persona source 42. Preferably, persona source 42 includes a database comprising a plurality of downloadable persona's. In some embodiments, persona source 42 is part of pre-paid server 16, especially if all access to the Internet is through pre-paid server 16. Alternatively, the two are separate entities. However, it should be appreciated that there is generally a correlation between connecting to an Internet and obtaining an electronic persona.

In a preferred embodiment of the invention, an electronic persona includes some or more of the following items of information and/or associations:

(a) e-mail address, for sending and/or receiving e-mail.

(b) Access codes to various sites and/or services, so that the user is not required to remember them and/or enter them on possibly insecure computers.

(c) On-line banking account, so that the user can perform financial activities form wherever he is located. It is noted however that the prepaid card itself may be used as electronic money in some embodiments of the invention.

(d) Credit card number. Again, so the user is not required to enter it. Rather, the persona source and/or pre-paid server can provide it to a service provider using a secure communication link.

(e) Personalization information, for example as described in Israeli application 125,432, filed Jul. 20, 1998, now PCT application PCT/IL99/00056, the disclosures of which are incorporated herein by reference. This information may be used to modify the way sites on the Internet respond to requests and/or displays data.

(f) Storage space. The storage may be used to permanently store files and/or other items of interest. Alternatively or additionally, when connected to the Internet a user downloads the files to a local computer on works on the local files, possibly uploading them after the fact. However, if there are security issues, a user may prefer to maintain the files only at the remote location.

(g) Personal page cache, especially for sites which may be off-line part of the time and/or to which connection is slow.

(h) Configuration files. An important aspect of working on the road is using production programs, such as word processors. Typically, a user will personalize and/or configure such production programs. In a preferred embodiment of the invention, configuration files are stored in association with the persona so that a user can quickly and preferably painlessly configure a computer to work, at least for some programs, in a manner similar to a computer to which he is used to. In a preferred embodiment of the invention, the configuration files include information for user-dependent voice recognition. Such voice recognition may be performed on the local computer and/or on a computer from the Internet. Alternatively or additionally, configuration includes setting up networking parameters so that accessing files on a remote computer is simpler (than manually setting up the mappings) or even transparent to the user.

(i) Cookies. One aspect of personalization is achieved at this date by cookies (text files) which are stored on a user's computer. These cookies are thus one type of configuration file. In addition, the cookies are used by content providers and advertisers to identify individual's computers and/or individual surfing habits. Thus, they comprise identifying information.

(j) Voice and/or fax mailbox. A user can receive voice messages and/or fax messages to a mailbox. When connected up, the user will generally desire to download and/or print the messages.

(k) Permissions. One important type of connection is to a workplace. In order to prevent anybody form accessing files at the workplace, a user is required to provide some type of access codes, which are associated with permissions. Additionally, such permissions may comprises desired limitations on spending and/or permission to view certain sites and/or types of sites.

(l) Networking definitions, which are especially important if the user connects to an existing network, such as the one at his workplace.

(m) Setup program(s). As can be appreciated the above items of information might require effort and/or know-how beyond what a user has, to be installed on an arbitrary computer. Such setup programs can preferably be used to automatically update any required information on such an arbitrary computer. In some cases, it may be more efficient to store setup instructions in association with the user, with the actual program itself being shared among users. In addition, setup programs may include drivers for certain devices which a user may find he is able to attach to the arbitrary computer.

In a preferred embodiment of the invention, a persona may include multiple instances of each of the above items, for example, a persona may include both a work e-mail address and a personal e-mail address. In another example, a persona may be hierarchically defined. A user may select the parent persona and then switch between sub-personas which share various characteristics, for example an identification or an e-mail. A hierarchical definition is useful when a user maintains multiple persona, having significantly overlapping definitions. By allowing one persona to inherit characteristics from another persona, creation and/or maintenance of persona may be made easier. An additional exemplary use of hierarchical personae is to provide a company “meta-persona” on which meta-persona the individual persona of workers can be based. Possibly, the worker's personae can be slaves of the company persona, in that they continuously change responsive to the company persona (including mood). In a preferred embodiment of the invention, a user is provided with a persona construction and/or maintenance program. Such a program is preferably able to download a current persona, allow a user to make changes and then upload it again. Alternatively or additionally, a user may modify persona at a WWW site provided by pre-paid server 16.

In a preferred embodiment of the invention, an electronic persona may be used to send faxes. Alternatively or additionally, an electronic persona may be used to print to a remote printer, providing that the persona has the required permissions. In a preferred embodiment of the invention, a plurality of available printers may be associated with the pre-paid server, so that a user can print to a geographically near printer and receive the printed pages and/or other types of output, by courier.

A complete or a partial electronic persona may be used when accessing the Internet from an arbitrary computer. Such computers are available, for example at friends, at associates, in hotels, from rental agencies and/or at conferences. Alternatively or additionally, an Internet pay-booth may be provided. In such a pay-booth, a person rents the usage of a computer and/or an Internet connection for a short time. Preferably an electronic persona, as described herein is used to properly configure the computer. Alternatively or additionally, a pre-paid Internet card is used to connect to the Internet, as described herein. In a preferred embodiment of the invention, a user can download production software, such as a word processor, to the arbitrary computer. Preferably, the downloaded software is a network version which does not require much download time. This software may be downloaded from the workplace or from a software provider. Preferably the electronic persona includes a license and/or a network license for the software. Alternatively or additionally, the computer-booth may include a plurality of selectively installable computer software packages, for example using a CD juke box. Alternatively or additionally, various standard software packages may be pre-installed. Possibly, at least some of the rental charge is paid responsive to the use of the software. In a preferred embodiment of the invention, when the use of the booth is terminated, the persona and/or other identifying information is erased from the booth computer, possibly being uploaded to the persona server or the user's workplace first.

In a preferred embodiment of the invention, access to the electronic persona and/or information stored therewith, is restricted. In a preferred embodiment of the invention, the information may be accessed by entering a password. Preferably, the password is a voice-lock.

In a preferred embodiment of the invention, the information associated with an electronic persona is kept secret and/or write protected from the persona user. Thus, when the persona user, for example a child, accesses the Internet, he will be forced to access the Internet through the persona and will not be able to overstep and desired limitations.

In a preferred embodiment of the invention, when a user changes his pre-paid card (for example if the card runs out) the electronic persona is carried from one card to the next. Preferably, once logged in a user can indicate to the system which cards to associate the electronic persona with. Alternatively or additionally, the association may be made when the card is purchased, for example by loading the card with the electronic persona. In a preferred embodiment of the invention, a pre-paid card may include only an access code. When accessing the Internet, the user identification given is that of the electronic persona. The pre-paid card number is used only as a password. Thus, more than one password may simultaneously be available for a single user ID. Alternatively or additionally, a plurality of Ids may be associated with a single pre-paid card. Alternatively or additionally, they may be associated with a set of pre-paid cards, to which additional pre-paid cards may be preferably added to replenish used amounts.

In a preferred embodiment of the invention, multiple simultaneous accesses from a plurality of locations using a single card ID and/or a single persona are not allowed. Alternatively or additionally, such simultaneous accesses may be allowed, possibly requiring a surcharge and/or a user's OK. Preferably, when a single persona is multiply accessed, changes in the persona require an OK from the user (the one which requested the change and/or the other user using the persona). Alternatively or additionally, copies of the persona are created if a change in the persona is desired while the persona is being used by another access point.

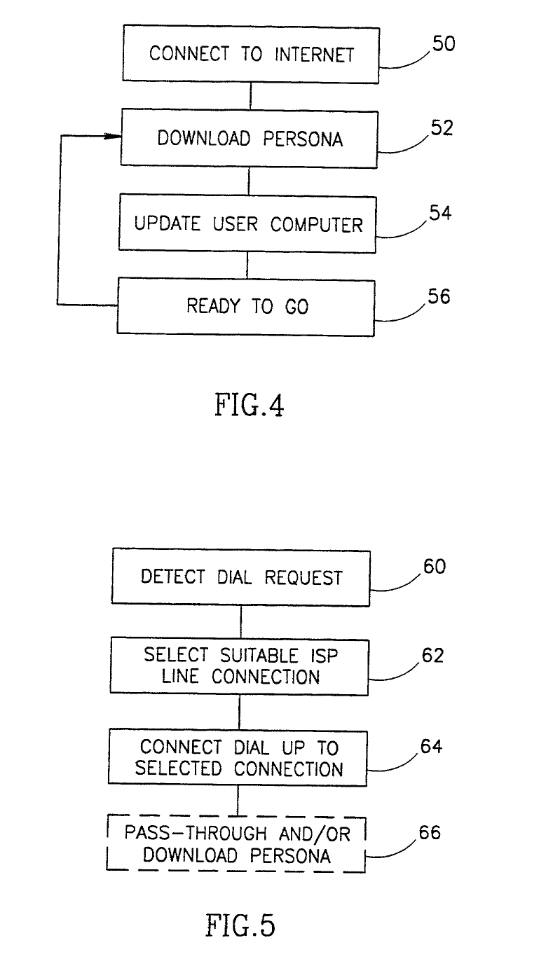

FIG. 4 is a flowchart of a process for providing an electronic persona on a computer, in accordance with a preferred embodiment of the invention. In a preferred embodiment of the invention, the persona is provided after the user connects to the Internet (50). Preferably, the electronic persona is downloaded from persona source 42, which may be incorporated in a pre-paid server 16. After the persona is downloaded, the user's computer needs to be updated (54). The user and electronic persona are then ready to go (56). Periodically and/or on request by the user and/or at an initiation of pre-paid server 16, the persona of the user may be replaced and/or updated.

Alternatively or additionally, to a persona being downloaded from a remote location by Internet, it may be downloaded by dial-up connection, for example before an Internet connection is completed. Alternatively or additionally, the persona may be stored on a diskette or other removable computer readable media. Alternatively or additionally, the persona may be stored in a memory portion of the pre-paid card itself. Alternatively or additionally, the persona and/or other information required to setup the computer may be stored using other portable means, for example on a portable computer, such as a palm computer. Thus, step 52 (and possibly 54) may precede step 50 and/or occur in parallel.

Referring to step 54. Updating the user's computer may include one or more of the following:

(a) Replacing the cookies with a new set of cookies, to reflect the new persona. Additionally other remotely accessible files may be modified and/or replaced. Preferably the old cookies/files are not erased but are stored in a separate location. Thus if a single computer is shared by several people (for example a rental computer) the users can switch the currently active persona without a lengthy downloading.

(b) Installing required software titles.

(c) Setting options and/or configurations in installed software titles.

(d) updating system information, for example networking, default printer and/or display preferences.

In one example, when a persona is downloaded, existing Internet cookies are moved to a temporary directory (or uploaded to the persona source for safe storage). E-mail settings are changed in an e-mail program. Preferably, a user indicates the type of e-mail program he is using. Alternatively or additionally, the install portion of the persona identifies the program automatically, for example by searching for files on the user's computer. Settings for an Internet browser are also set, for example including a proxy server address and/or other user preferences. In some cases, these settings may be achieved by modifying configuration fires. In other case, these settings may require changes in a system registry. In still other cases, these changes may require patching installed programs.

In a preferred embodiment of the invention, when the user is finished working, the persona is updated with the changes which occurred while the user was working. Alternatively or additionally, the persona is continuously being updated.

In a preferred embodiment of the invention, a cookie or other remotely accessible file is stored on the computer to track changes in the persona, so that a future complete download of a persona may be avoided. Alternatively or additionally, such a configuration management is used to limit bandwidth when uploading changes in the persona to persona source 42.

In a preferred embodiment of the invention, the persona is used to coordinate information push. One type of information push is advertising, which may be dependent on the above described parameters. Alternatively or additionally, advertisements (for information push and otherwise) may depend on the card ID number, the card source (i.e., shoe advertisements if the card was received by a shoe seller) and/or the amount of access time remaining on the card and/or a pattern of card usage, for example if the user surfs in binges or at a constant rate and/or variations in the card balance. Alternatively or additionally, the persona attributes may be used for information push, where the information is desired by the user, for example, for announcing news or stock quotes to the user, based on the persona.

In a preferred embodiment of the invention, the persona is used to affect the interaction of a user with non-Internet software. In one example, the suggestion of spelling corrections or suggestion or a replacement word from a thesaurus can be dependent on the “mood” of a user. This mood may be determined based on interactions of the use with software on the computer or based on interactions with the Internet.

Alternatively or additionally, a virtual personality may be used to assist in generating an Internet presence, such as a WWW site. In a preferred embodiment of the invention, the virtual personality can automatically (partially or completely) construct, criticize, self index (in data indexes), request listing in suitable sites (for example a Napoleonic site in a site containing lists of historically oriented sites), and/or create key-words for a site. Various automation level may be applied. In a most automatic system example, a WWW site is constructed from scratch base don the personality, for example to mirror the personality and/or include sites most often visited by the persona. In a less automatic example, a user may suggest what type of information should be displayed in the site, what type of organization the site should follow and/or other guidelines for the site. In a preferred embodiment of the invention, these guidelines are selected from a set of available guidelines. Alternatively or additionally, the guidelines are provided by the user.

In a still less automatic example, a user can construct the site manually. However, when selecting an element to include in the site, for example a background or an image, the construction software preferably presents a limited and/or sorted selection, filtered responsive to the personality.

In a still less automatic example, a software will critic a constructed site, with regard to its compliance with a certain mood or personality. Alternatively or additionally, a software can generate index terms or suggest, request listing or even list the site in suitable sites, portals or indexes.

In some cases, various combinations of these levels of automaticity may be found in a single software.

In a preferred embodiment of the invention, a WWW site, one constructed as described herein or one constructed otherwise, is modified responsive to a user's instantaneous mood and/or persona, for example to match the mood. Alternatively, such matching may be performed on a periodic basis, such as once a day, or in response to special events, such as a user's request.

Alternatively or additionally, a single site can be represented by a plurality of sites, each corresponding to a different virtual personality, so that when accessing the site, a suitable version of the site may be accessed based on the desires of the accessor.

Alternatively or additionally, to a site which passively matches a mood, a site can include active components to match an accessor. These active components may be implemented as part of the server hosting the site, for example as scripts. Alternatively or additionally, these components may be implemented as part of the site itself, for example by Java applets. In a preferred embodiment of the invention, the decision which of these components to include and/or their configuration, is decided when constructing the site, preferably using a personality-responsive construction software as described above. Alternatively or additionally, a user may modify a site after it is constructed.

Alternatively or additionally, to a user modifying a site or a site responding to a particular accessor, a site can modify its personality responsive to the actions of a plurality of accessors In one example, if a plurality of accessors desire a gloomy mood, the site may be come gloomier. Alternatively or additionally, such automatic adaptation of a site may be extended to data display, for example, more often requested data being shifted to locations where it is more easily accessible. In some access, mood changing of the site may be used to reject web surfers and/or to target a specific audience. Such targeting may be, for example automatic, based on a pre-programmed rules and/or on requested patterns of access. Alternatively or additionally, manual modification may be practiced.

Referring back to FIG. 1, one type of pre-paid server 16 in accordance with a preferred embodiment of the invention is a pre-paid advertising broker. In this use of a pre-paid account, a user who desires to advertise purchases an amount of advertising, possibly maintained as a count of advertising units, and uses that account to advertise on the Internet. Alternatively or additionally, such an account is used for e-mail and telephone advertising. In one exemplary embodiment of the invention, the user does not need to contact any particular advertiser. Rather, once he purchases the account, he can spread his advertising between any advertisement service that accepts the account. Thus, it is practical to place even a small number of advertisements at a particular advertisement provider. Alternatively or additionally, anonymity is maintained.

In a preferred embodiment of the invention, a user can control the content and/or spread of the advertising, independently. In one example, pre-paid server 16 provide an Internet site which is accessed by user computer 12. In an exemplary situation, a user can reduce the number of exposures in a WWW site from which enough hits have been received. Possibly, this adjustment of advertisement placement is performed by an automatic program, possibly rule based which runs at the user, the pre-paid server or at a different computer. Alternatively or additionally, a user can vet which at exact sites and/or user profile the advertisements are presented. Possibly, the user can perform this vetting responsive to statistics of site accessing. These statistics can also be real-time statistics, which are determined on the fly, rather than after a delay such as days or weeks.

Another possible advantage of pre-paid advertising is the ability to start and end the campaign in real-time and/or change its geographical and/or demographic targeting, for example once enough hits have been received or responsive to an external event, such as a weather change. Also, better control over outlay of money can be achieved, for example automatically presenting more successful advertisements over less successful ones, without waiting for after-the-fact statistics. Alternatively or additionally, a user can match advertisement placement statistics to purchasing statistics, to better fine tune the advertising campaign. This and other types flexibility may be difficult to achieve at a particular advertising provider. However, if the advertising is controlled by the user, he can run any desired program to control it. In some cases, vetting of the content of the advertising may be required by the pre-paid server or by the advertisement placers. However, In a preferred embodiment of the invention, at least some of the slots available for advertisement placement do not require vetting, so that a user does not require any prior disclosure of his advertisements and/or can modify them in real time.

In some cases pre-paid server 16 will provide a service of automatically generating a distribution of the advertisements between available slots, for example, in a random manner or to match a particular sales program of the user.

Generally, the advertising units are exposures—i.e., one unit for each time the advertisement is presented. However, other advertisement units may be used, and an exchange rate may be defined between the units and/or separate sub-accounts managed for different types of units. In one example, a unit is a hit, i.e., a selection of the advertisement by the user possibly a hit is defined even by a user's mouse lingering over the advertisement, or by another indication that a user's attention is captured by the advertisement, such as a long viewing time of a page which is normally skimmed by or the filling out of a questionnaire by the user. Other types of units include purchase started at the advertisement, which may be charged as units or as a percentage of the sale.

In some cases fractional units may be desirable, for example to assign different weights to different sizes, location, dynamics, context matching and/or demographic targeting of advertisements. In some cases advertising may be implemented by listing a site in a search index and/or by modifying the probability of that site being listed first on a list of search results. Possibly, in such advertising the unit is the duration of time for which the listing is maintained alternatively or additionally to the number of times the site was listed as a search result, viewed and/or as a function of the proximity of the listing to the beginning of the list of search results.

In a preferred embodiment of the invention, bonus activities, as described herein, may be used to supply advertisement credit. Thus, for example, a person who views ten advertisements may be credited with a single advertisement of his choice, for example to advertise his WWW site. In another example, the advertisement viewing of an entire company may be accumulated towards credit for the company advertising.

It should be appreciated that some of the above method of advertising may also be applied to non-pre-paid based methods, in accordance with other preferred embodiments of the invention.

Another type of Internet service which is amenable to pre-payment is the provision of a WWW site. In a preferred embodiment of the invention, A user is charged based on the time that his WWW site is available, based on the number of hits to the WWW site, based on the source of the hits and/or based on the frequency of the hits. Alternatively or additionally, standard-type charges may also apply, for example, bandwidth and memory requirement based charges. In some cases, a user's WWW site may include advertisements, which, when viewed and/or activated generate a revenue for the user. In a preferred embodiment of the invention, this revenue is entered into the pre-paid account. Alternatively or additionally, this revenue is used by the site provider to directly offset the charges for of maintaining the site.

Another type of Internet service is amenable to pre-payment is e-mail. In a preferred embodiment of the invention, a user is charged for maintaining an e-mail address and/or per incoming or outgoing e-mail. Preferably, a mechanism is provided for the user to screen undesirable e-mail messages so that he does not pay for them. Alternatively or additionally, a user may be credited into a pre-paid account for viewing advertising e-mail possibly, the viewing is tracked by internal mechanisms of the e-mails program. Alternatively or additionally, the viewing is tracked by a reply e-mail that the user is required to send, possibly including answers to questions posed in the e-mail.

FIG. 5 is a flowchart of a process for ISP independent Internet connection, in accordance with a preferred embodiment of the invention. In FIG. 2A, a user dialed up an access number, in order to initiate an Internet connection. Preferably, the user dials an “800” or a “900” number. Generally, a local access number may not be available or a user might not have it written down. Although a call-back configuration is contemplated for one embodiment of the invention, where the pre-paid server calls up the user computer, a non-local telephone connection may still be required. In a preferred embodiment of the invention, a user is connected using a local ISP, without being required to register. In a preferred embodiment of the invention, the pre-paid provider is billed by the local ISP. Alternatively or additionally, the connection utilizes an electronic persona, possibly one which is automatically adapted to an ISP, preferred proxy servers and/or geographical locality, so that the identity of the ISP is transparent to the user. In a preferred embodiment of the invention, the ISP is utilized only as a port to the Internet and is not required to provide other services, such as an e-mail account.

The connection process starts when a dial request is detected by the pre-paid server (60). This may be in response to a local call and/or a long distance call. Then, a suitable ISP and/or connection line is selected (62). In a preferred embodiment of the invention, a pre-paid server may buy and/or lease connection time, bandwidth and/or users from local ISPs and/or rent them ad-hoc. Alternatively or additionally, a new userid may be created for each such connection request. Pre-paid server 16 then handles the connection of user 12 to the Internet, utilizing the selected connection (64), preferably a dial-up connection, but possibly a different type of connection, such as a LAN connection or a cable modem connection. Optionally, a suitable electronic persona is downloaded to user 12 (66).

It should be noted that the entire process (steps 60-66) may be performed by the pre-paid server without the user being required to enter any information. Alternatively or additionally, the process is semi automatic, for example with the user being informed of a telephone number to call and/or access codes to use. Preferably, when pre-paid server 16 purchase several connection userids from the local ISP, the next free userid is assigned to the next connection request.

In a preferred embodiment of the invention, steps 62-66 are delayed until the users connects to the Internet and/or otherwise proves his identity to pre-paid server 16, for example by dialing an access code and/or PIN number.

Alternatively to such a service being provided by a pre-paid server 16, the above service may be provided by a user's own local ISP. When the user is at a remote location, he connects using the above protocol to a local ISP (or a local access number for a regional or global ISP), with the user's own ISP taking the part of the pre-paid server. The local ISP then charges the user's ISP for any time and/or other services provided. In embodiments where an ISP is used as a charge account provider, preferably the user's ISP carries the tab. Alternatively or additionally, the local ISP may perform this service, possibly for a fee.

In a preferred embodiment of the invention, the local ISP will insert advertisements and/or display a WWW page to the user, in order to entice him and/or offset costs. Alternatively or additionally, such advertisement may be blocked and/or may be provided by the user's own ISP.

In an alternative preferred embodiment of the invention, step 62 may include manual intervention. In a preferred embodiment of the invention, a user may select which ISP use for connection before substantially any connection to the Internet. Preferably, the pre-paid server suggests a limited number of ISPs for the user to choose between. Preferably the selection is made using an IVR system. Alternatively or additionally, the user dials a number selecting which ISP to select. Alternatively or additionally, a user provides a set of rules by which to choose an ISP and the user may select which set of rules the server is to use. Alternatively or additionally, a user dials up a different access number and/or a different extension” number, depending on the desired ISP. In a preferred embodiment of the invention, pre-paid server 16 suggest to a user which ISP to select. Such suggestion and/or ranking of available ISPs may be dependent on the considerations mentioned above for automatic selection. Alternatively or additionally, the selection may depend on the persona, card ID and/or work habits. In one example, a first ISP may be preferred if only accessing local sites and another ISP may provide better (if more expensive) service if accessing over-seas sites. In a preferred embodiment of the invention, the two ISPs are presented, with an indication of this difference. Alternatively or additionally, the type of access performed by the persona may be used to suggest one ISP over the other.

In a preferred embodiment of the invention, a list of relevant ISPs may be presented. Preferably the presentation includes rates, speed and/or quality of service, special promotions and/or other information about the ISPs which can aid a user in selecting between the ISPs, at least for the instant connection.

In a preferred embodiment of the invention, when a list of ISPs is (preferably vocally) presented to a user, the presentation may include advertisement materials. Alternatively or additionally, any of the above indications may be presented using a text-to speech emulator. Alternatively or additionally, a user may connect to the Internet using any provided ISP, receive a list of possible ISPs, disconnect and then reconnect with the selected ISP. In this embodiment, the user may select the ISP to connect to while on the Internet, so that when he dials he is automatically connected to the previously selected ISP.

In an alternative embodiment of the invention, an Internet connection server, for example a phone number with an IVR, may be used to provide a user with a selection of ISPs to use. Alternatively or additionally, a data connection may be provided, at least for selecting the ISP. Preferably the connection uses a 1-800 number. Alternatively or additionally, the connection uses a 1-900 number.

The present invention has generally been described above as using a pre-paid Internet card. Alternatively or additionally, a long distance telephone company may provide the “pre-paid” service for example using a pre-paid telephone card. In a preferred embodiment of the invention, the pre-paid card is used to pay both for the Internet access and for the telephone connection costs. In a preferred embodiment of the invention, the connection costs depend on the distance (or telephone rates) between the connection location and the ISP which is used. Thus, a user is only required to remember one set of code numbers. This embodiment may be usefully provided for example in the embodiment of FIG. 2A. The telephone company preferably reimburses the ISP used.

Alternatively or additionally, a credit card may be used. In a preferred embodiment of the invention, when a credit card is used to connect to the Internet, a virtual pre-paid card is created which includes only a small amount of access time/electronic money. When this small amount is used up a user may recharge it at will. However, there is no danger that a user's credit card number will be stolen, since it need never be provided on the Internet. The virtual card may be transparent to the user, since it may be embedded in an electronic persona.

Alternatively to charging for pre-paid cards, in a preferred embodiment of the invention, a user is provided a pre-paid card free of charge or at a nominal charge. However, Internet access may then include a larger than common number and/or type of advertisements and/or promotions. Alternatively or additionally, the user may be continuously required to fill questionnaires and respond to other requests.

It should be appreciated that while many of the features described herein are especially useful in a pre-paid access card configuration, many of these features, especially those relating to access control, gambling, taxing of income, electronic persona, billing, cost control and rebates may also be advantageously used for non-pre-paid Internet access, for example flat-fee based, bandwidth based and/or hourly fee based.

It will be appreciated that the above described methods of Internet billing may be varied in many ways, including, changing the order of steps, which steps are performed on-line and which steps are performed off-line. In addition various distributed and/or centralized configurations may be used to implement the above invention, preferably utilizing a variety of software tools. In addition, a multiplicity of various features, both of methods and of devices have been described. It should be appreciated that different features may be combined in different ways. In particular, not all the features shown above in a particular embodiment are necessary in every similar preferred embodiment of the invention. Further, combinations of the above features are also considered to be within the scope of some preferred embodiments of the invention. Also within the scope of the invention are computer readable media on which software, for performing part or all of a preferred embodiment of the invention, are written. It should also be appreciated that many of the embodiments are described only as methods or only as apparatus. The scope of the invention also covers hardware and/or software adapted and/or designed and/or programmed to carry out the method type embodiments. In addition, the scope of the invention includes methods of using, constructing, calibrating and/or maintaining the apparatus described herein. When used in the following claims, the terms “comprises”, “comprising”, “includes”, “including”, “having” or their conjugates mean “including but not limited to”.

It will be appreciated by a person skilled in the art that the present invention is not limited by what has thus far been described. Rather, the scope of the present invention is limited only by the following claims.

1-87. (canceled)

88. A method of pre-paid Internet access, comprising:
accessing an Internet using an anonymous prepaid account, which access deducts from a balance of said account; and
performing one or more activities not directly related to an issuer of said account and at most indirectly related, while connected to said Internet, which activities incidentally modify said balance additionally to said accessing, which activities are other than a requesting by an accessor of said account to transfer funds to said account from another account.

89. A method according to claim 88, wherein said one or more activities increase said balance.

90. A method according to claim 89, wherein said one or more activities comprise accessing a particular site.

91. A method according to claim 89, wherein said one or more activities comprise replying to a questionnaire.

92. A method according to claim 89, wherein said one or more activities comprise providing personal identifying information.

93. A method according to claim 89, wherein said one or more activities comprise requesting a service and wherein said balance is increased responsive to said service not being performed in a satisfactory manner.

94. A method according to claim 93, wherein comprising automatically determining, using a computer, if said service is performed satisfactory.

95. A method according to claim 94, wherein said service comprises a search and wherein satisfactory service comprises receiving suitable search results.

96. A method according to claim 89, wherein said one or more activities comprise viewing an advertisement.

97. A method according to claim 88, wherein said one or more activities decrease said balance.

98. A method according to claim 97, wherein said one or more activities comprise purchasing a physical item on the Internet.

99. A method according to claim 97, wherein said one or more activities comprise purchasing a service on the Internet.

100. A method according to claim 97, wherein said one or more activities comprise downloading software.

101. A method according to claim 97, wherein said one or more activities comprise posting an advertisement.

102. A method according to claim 97, wherein said one or more activities comprise retrieving information from an information providing service.

103. A method according to claim 97, wherein an accsessor of said Internet using said account is queried for conformation before at least one of said activities cause a charge deduction.

104. A method according to claim 97, wherein said Internet connection is mediated by a pre-paid server and wherein said pre-paid server transfers funds to pay for at least one of said one or more activities.

105. A method according to claim 88, wherein said one or more activities include activities which increase said balance and activities which decrease said balance and wherein said increasing activities and said decreasing activities cancel each other out, at least in part.

106. A method according to claim 88, wherein said balance is constrained to remain positive.

107. A method according to claim 88, wherein said balance is allowed to become negative.

108. A method according to claim 88, wherein a deduction responsive to said access is dependent on a quality of service of said connection.

109. A method according to claim 108, wherein said quality of service comprises a bandwidth.

110. A method according to claim 108, wherein said quality of service comprises a response time.

111. A method according to claim 108, wherein said quality of service comprises an image quality.

112. A method according to claim 108, wherein said quality of service comprises a measure of advertising included in said Internet access.

113. A method according to claim 108, wherein said quality of service is a predefined quality of service.

114. A method according to claim 108, wherein said quality of service is an actual quality of service.

115. A method according to claim 88, wherein said access to said Internet is anonymous.

116. A method according to claim 88, wherein a user name is associated with said account after said account is used for a first time.

117. A method according to claim 88, wherein an e-mail address is associated with said account.

118. A method according to claim 88, comprising presenting a balance of said account to said user, while said user performs said one or more activities.

119. A method according to claim 88, comprising limiting access to said Internet responsive to limitation information associated with said account.

120. A method according to claim 119, wherein said information is associated with said account after said account is first used.

121. A method according to claim 88, wherein said account has a virtual personality associated therewith.

122. A method according to claim 121, wherein said accessing is modified responsive to said virtual personality.

123. Apparatus comprising:
a computer; and
a storage media having software stored thereon, wherein said software supports said accessing and said modifying said account according to claim 88.

124. A method of maintaining pre-paid account, comprising:
providing a first pre-paid Internet access account associated with personalized information;
providing a second pre-paid card; and
transferring at least a part of a balance between the account and the card.

125. A method of Internet access, comprising:
detecting a connection request, by a connection server;
automatically selecting, by the connection server, an ISP (Internet Service Provider), from a plurality of available providers, for the connection; and
automatically performing the connection using the automatically selected ISP.

126. A method according to claim 125, wherein said connection server is implemented on a computer used to connect to the Internet.

127. A method according to claim 125, wherein said connection server is implemented on a computer other than one used to connect to the Internet.

128. A method of Internet connection, comprising:
dialing up an Internet access number, to start a session;
selecting an ISP (Internet Service Provider) after said dialing;
indicating said selected ISP during said session;
connecting to the Internet after said indicating, using said selected ISP; and
deducting for said connection from a pre-paid account, said account being independent of said selected ISP.

129. A method according to claim 128, comprising automatically presenting, by a connection server, to a user a selection of suitable ISPs, for said selecting.

130. A method according to claim 128, wherein said session is not an Internet session.

131. A method of Internet billing, comprising:
connecting to an Internet via a cost server;
accessing a plurality of Internet sites via said cost server, using an Internet interaction protocol, which access does not require additional actions beyond selecting a URL (Uniform Resource Locator) by a user; and
generating a debit, which debit accumulates charges at a different rate for each accessed site.

132. A method according to claim 131, wherein said Internet is accessed using a pre-paid Internet account, which account is debited using said debit.

133. A method according to claim 131, comprising presenting an indication responsive to said debit to said user during said access.

134. A method according to claim 131, wherein said cost-server is connected to via the Internet.

135. A method of pre-paid access, comprising:
providing a pre-paid account;
connecting to an Internet, debiting said account for said connection at a debit rate; and
modifying said rate responsive to a quality of service for said connection.

136. A method according to claim 135, wherein said quality of service is requested by a user of said account.

137. A method according to claim 135, wherein said quality of service is determined based on parameters of the actual connection.

138. A method of configuring a computer, comprising:
connecting to an Internet, using an arbitrary computer;
downloading from the Internet a virtual personality; and
automatically updating the arbitrary computer using the virtual personality, to be configured as indicated by said personality.

139. A method according to claim 138, wherein automatically updating comprises automatically updating a source e-mail address in an e-mail program on the arbitrary computer.

140. A method according to claim 138, wherein automatically updating comprises configuring production software program on said computer responsive to said download.

141. A method according to claim 140, wherein said production software comprises a word processor.

142. A method of placing an advertisement using a pre-paid advertising account, comprising:
slotting advertisements in available advertising slots in an Internet;
charging said slotting to said pre-paid account; and
controlling, by a user, an actual presentation of said advertising responsive to a real-time status of said account.

143. A method according to claim 142, wherein said user chooses said slots.

144. A method according to claim 142, wherein said controlling comprises modifying a targeting of said advertisements.

145. A method according to claim 142, wherein said controlling comprises modifying an exposure rate of said advertisements.

146. Software for WWW site construction, comprising:
a user input unit for receiving requests from a user;
a personality receiving unit for receiving a virtual personality associated with said user;
a selection display unit for selecting options to said user, which selections are displayed responsive to said received virtual personality, and which user input is used to select from said selections; and
a site constructor which generates a portion of said site responsive to selections by a user.

147. A method of WWW site maintenance, comprising:
determining a current virtual personality of a user associated with a particular WWW site; and
modifying a presentation of said site responsive to said determined virtual personality.

148. A method according to claim 147, wherein said modifying comprises modifying display files.

149. A method according to claim 147, wherein said modifying comprises modifying a behavior of active components associated with said site.

150. A method according to claim 147, wherein said modifying comprises replacing display files.

151. A method of commanding a computer to perform an action, comprising:
providing an Internet browser comprising at least an address entering portion and a page display portion;
entering at least an indication of a command, which command does not meet standard URL definitions, into said address portion; and
executing said command, which command is other than a command to retrieve or connect to a URL.

152. A method according to claim 151, wherein said indication comprises an explicit command.

153. A method according to claim 151, wherein said indication comprises an implicit command.

154. A method according to claim 152, wherein said command modifies a file on a computer used for said browser.

155. A method according to claim 152, wherein said command modifies a file on a computer remote from the said browser.

156. A method of manipulating a pre-paid card, comprising:
receiving an anonymous pre-paid account;
associating personal information with said account; and
interacting with an Internet using said account, which interaction is modified by said personal information.

157. A method according to claim 156, wherein said personal information comprises a user identification.

158. A method according to claim 156, wherein said personal information comprises at least one limitation on said card.

159. A method according to claim 158, wherein said at least one limitation comprises a limitation on cost expenditure using said account.

160. A method according to claim 158, wherein said at least one limitation comprises a limitation on accessing certain sites.

161. A method according to claim 156, wherein said personal information comprises a virtual personality.

162. A method according to claim 156, wherein said interaction modifies a balance of said account.

163. A method according to claim 156, wherein said personal information comprises a storage location on a computer connected to said Internet.

164. A method according to claim 156, wherein said interaction comprises accessing the Internet.

165. A method according to claim 156, wherein said pre-paid account is limited to purchasing information.

166. A method according to claim 156, wherein said pre-paid account is limited to purchasing advertising.

167. A method of calculating a pre-paid account balance, comprising:
deducting from said account responsive to activities charged to said account, which activities include an interaction with an Internet;
determining a quality of said activity; and
adding to said account responsive to said determined quality, if said quality is deemed unsatisfactory.

168. A method of doing business, comprising:
producing a plurality of pre-paid cards for interacting with the Internet and purchasing over the Internet; and
selling said cards to individual customers.

169. A method according to claim 168, wherein said cards are associated with accounts for accessing the Internet.

170. A method according to claim 168, wherein said cards are associated with accounts for purchasing advertisements.

171. A method according to claim 168, wherein said cards are associated with accounts for purchasing information.

172. A configurable computer, comprising:
a computer having production software stored in association therewith;
software loaded on said computer, which software configures said production software to match a user, responsive to personalization information provided by said user;
usage tracking software for charging for the use of said computer; and
a data port for providing said personalization information by said user.

173. A computer according to claim 172, wherein said data port comprises an Internet connection.

174. A computer according to claim 172, wherein said data port comprises a connection to a portable computer.

175. A method of satisfaction guarantee, comprising:
performing an activity over an Internet using an anonymous prepaid account;
providing an indication that said activity was unsatisfactory; and
receiving a refund to said pre-paid account, responsive to said indication.

176. A method according to claim 88, wherein deductions from said account are in small denominations.

177. A method according to claim 88, wherein deductions from said account are in denominations selected from a small set of denomination values.

178. A method according to claim 125, comprising pre-purchasing a plurality of connections for providing said available ISPs.

179. A method according to claim 125, comprising deducting for said connection from a pre-paid account, said account being independent of said selected ISP.
